(19) United States
(12) Patent Application Publication
(10) Pub. No.: US 2007/0220114 A1
(43) Pub. Date: Sep. 20, 2007

(54) Advanced search feature for UPnP media content

(75) Inventors: Kari Kaarela, Oulu (FI); Kirmo Koistinen, Oulu (FI); Timo Tervo, Oulu (FI); Hannu Kauniskangas, Oulu (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/377,948

(22) Filed: Mar. 16, 2006

(51) Int. Cl. G06F 15/16

(52) U.S. Cl. 709/219

(57) ABSTRACT

An advanced search system for UPnP media items such as audio and video. According to the present invention, a content directory service of a UPnP media server is capable of creating various “favorite” lists of most requested, accessed and/or played media items. A UPnP AV control point, when entering a UPnP network including the media server, can request a particular favorite list based upon a wide variety of criteria. In response to this request, the UPnP media server can provide the UPnP AV control point with the requested favorite list.

### FIELD OF THE INVENTION

The present invention relates generally to Universal Plug and Play (UPnP) devices. More particularly, the present invention relates to advanced searching features for audio/video in a UPnP environment.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

UPnP is one of the technical cornerstones of the Digital Living Network Alliance (DLNA), a group which is working towards a wired and wireless interoperable network of Personal Computers (PC), Consumer Electronics (CE) and mobile devices in the home, enabling a seamless environment for sharing and growing new digital media and content services. UPnP technology defines an architecture for pervasive peer-to-peer network connectivity of intelligent appliances, wireless devices, and personal computers of all types. UPnP technology is designed to bring easy-to-use, flexible, standards-based connectivity to ad-hoc or unmanaged networks whether in the home, in a small business, public locations, or systems connected to the Internet. UPnP technology provides a distributed, open networking architecture that leverages TCP/IP and web technologies to enable seamless proximity networking, in addition to providing control and data transfer among networked devices.

The UPnP Device Architecture (UDA) is designed to support zero-configuration, “invisible” networking and automatic discovery for a breadth of device categories from a wide range of vendors. With UDA, a device can dynamically join a network, obtain an IP address, convey its capabilities, and learn about the presence and capabilities of other devices.

Current UPnP devices use a media server content directory service (CDS) to search for audio and/or video content located on a media server. However, the search features of the media server CDS are relatively limited in nature. Additionally, using the media server CDS can be very tedious for a user when searching for content such as the user's favorite music, particularly if there are several UPnP audio/video servers in the network at issue.

It would therefore be desirable to provide an improved system for searching for audio/video content in UPnP networks.

### SUMMARY OF THE INVENTION

The present invention comprises a system and method for extending the search capabilities of the UPnP audio/video content directory service. According to the present invention, a user (control point) is capable of querying/searching for “favorite” lists of media from the specific media server at issue. This can be particularly useful in situations where a user is visiting a “foreign” UPnP network or media server. For example, a user may visit a friend's home. In another embodiment, a person could visit a music shop where it is possible to buy and/or download music through a proximity network. In both of these situations, the user can quickly and easily browse the favorite lists included in the respective media server, receiving rapid access to more popular or preferred audio/video items through a proximity network. The present invention could also be taken advantage of by virtually any type of handheld device with UPnP functionality.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation showing a UPnP audio/video (AV) control point entering a local UPnP network serviced by a media server in accordance with one embodiment of the present invention;

FIG. 2 is a flow chart showing the implementation of a first embodiment of the present invention;

FIG. 3 is a flow chart showing the implementation of a second embodiment of the present invention;

FIG. 4 is a perspective view of a mobile telephone that can be used in the implementation of the present invention; and

FIG. 5 is a schematic representation of the telephone circuitry of the mobile telephone of FIG. 4.

### DETAILED DESCRIPTION OF PREFERRED EMBODIMENTS

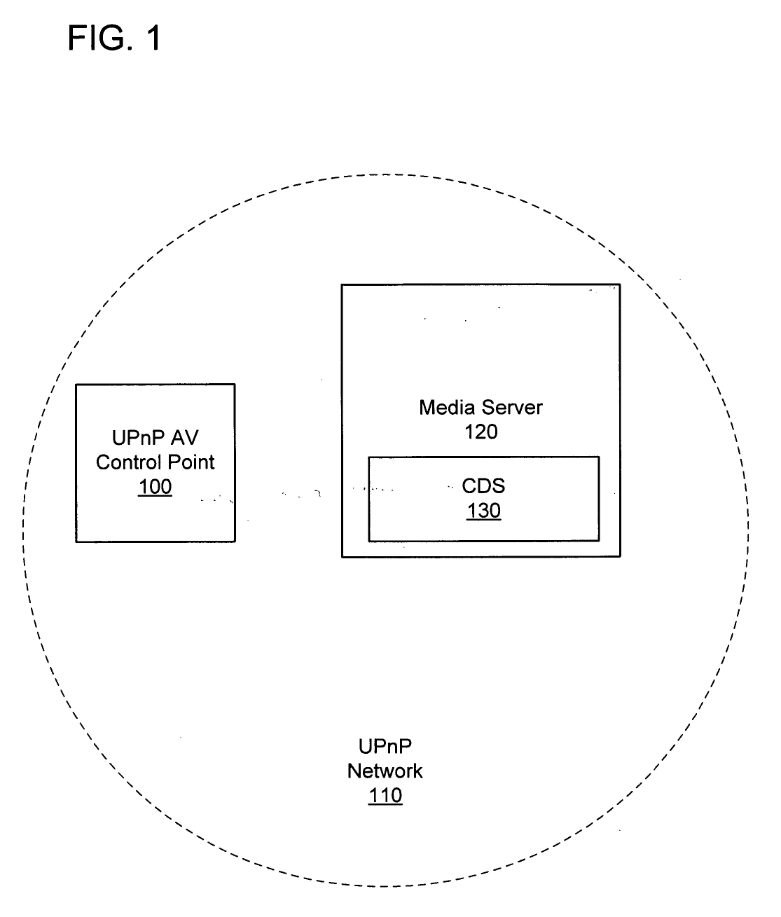

The present invention comprises a system and method for extending the search capabilities of the UPnP audio/video content directory service. FIG. 1 is a depiction of a UPnP environment where a UPnP AV control point 100 enters a local UPnP network 110, which is serviced by a media server 120. According to the present invention, a user (control point) is capable of querying/searching for “favorite” lists of media from the specific media server 120 at issue. This can be particularly useful in situations where a user/UPnP AV control point 100 is visiting such a “foreign” UPnP network 110 or media server 120. The types of media from which favorite lists can be created include, but are not limited to audio content, video content, image content, and combinations (e.g., music videos) thereof. For example, the media on the media server 120 can include only music tracks, or it could also include television shows, movies, music videos, photographs, and other types of content.

The primary functionality of invention includes the ability of a UPnP AV media server CDS 130 to collect the favorite lists of the music, video, images, etc. played from that particular CDS. Additionally, the functionality includes the ability of the UPnP AV control point 100 to make searches to UPnP AV media servers 120 based on various types of favorite lists. These favorite lists may comprise, for example, “most played titles” or “most played artists” as a search criterion. The user/UPnP AV control point 100 can define the number of entries to be returned in the favorite list. For example, the user may specifically ask for the fifteen most played titles on a server or servers. Other search criteria and parameters may also be used. Furthermore, the functionality of the present invention includes the ability of the UPnP AV media server CDS 130 to reply with the required “favorite list” as queried by a UPnP AV control point 100.

In one embodiment of the present invention, two new features are added to the media server CDS 130. The first feature comprises the ability to collect various favorite lists. This is accomplished through the ability of the CDS 130 to collect media usage information. The second feature involves supporting queries/searches related to the favorite lists.

According to the present invention, favorite lists can be based upon a wide variety of criteria. These criteria include, but are not limited to, (1) counting how many times each music track, video clip, television episode or series, etc. has been played/watched (i.e., favorite tracks); (2) counting how many times tracks/clips in each music/video genre have been played (i.e., favorite genres); (3) counting how many times tracks from each compact disc (CD) or album have been played (i.e., favorite CDs); (4) counting how many times each artist's tracks have been played (i.e., favorite artists); (5) counting how many times tracks from each decade or other musical era have been played (i.e., favorite decades); (6) counting how many times movie clips that contain the same actor have been watched (i.e., favorite actors); and (7) counting how many times movie clips that are produced in a specific year have been watched (i.e., favorite years). As mentioned above, favorite lists based upon other criteria may also be used relating to date, location, individual, group, style, or other categories.

According to the present invention, the media server CDS 130 supports a UPnP advanced search functionality that returns the requested favorite list. The functionality can also be implemented into the existing search action of CDS 130 as new search criteria (i.e., a new type of search property definitions). Some of the above-defined search criteria, such as genre, are already supported by the existing UPnP CDS 130 search action definition. Such criteria could therefore be used without modification to the current specifications.

In an alternative implementation of the present invention that does not require any changes to the current CDS 130 specification, the media servers 120 create a specific favorites container and sub-containers based upon the above-identified search criteria or other criteria. In this implementation, the CDS 130 would be required to automatically maintain the containers.

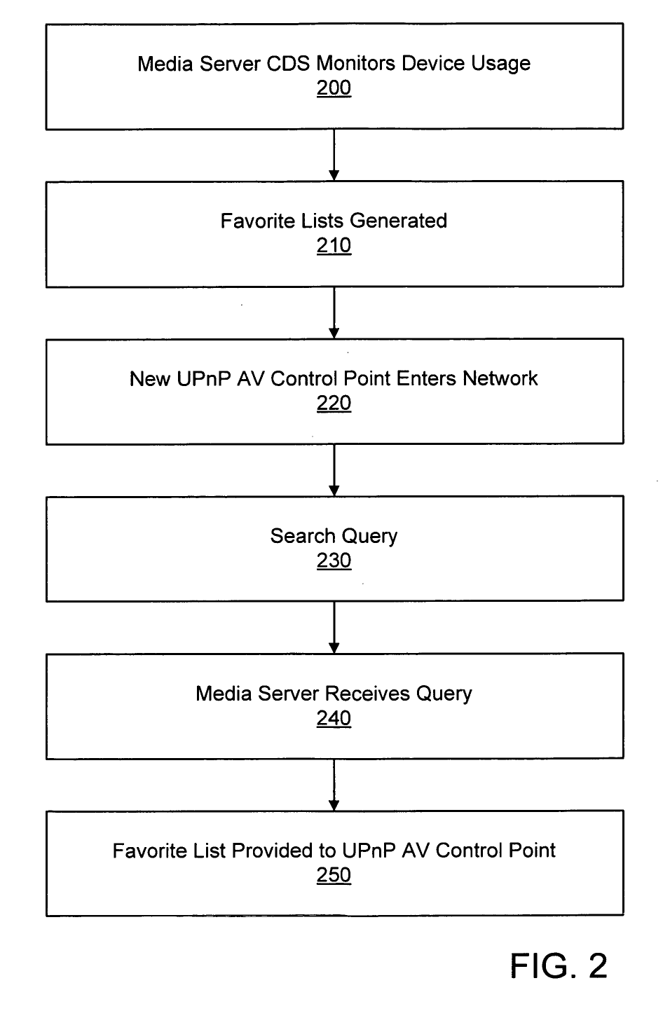

FIG. 2 is a flow chart showing the implementation of one embodiment of the present invention. At 200 in FIG. 2, the CDS 130 of a media server 120 for a local UPnP network 110 monitors the usage of UPnP devices within the local UPnP network 110, keeping track of the number of times each media item has been requested, accessed, and/or played by devices. At 210, the CDS 130 generates “favorite” lists for each category that is supported by the search system of the present invention. At 220, a new UPnP AV control point 100 enters the local UPnP network 110, which is serviced by a media server 120. At 230, a user enters a search query for the most popular media items of a particular criteria. As discussed above, the actual parameters may be modified in various embodiments, for example by requesting only a certain number of the most popular content items in the search. At 240, this query is received by the media server 120. At 250, the media server 120 retrieves the desired favorite list from the CDS 130 and transmits it back to the UPnP AV control point 100 in accordance with the search parameters.

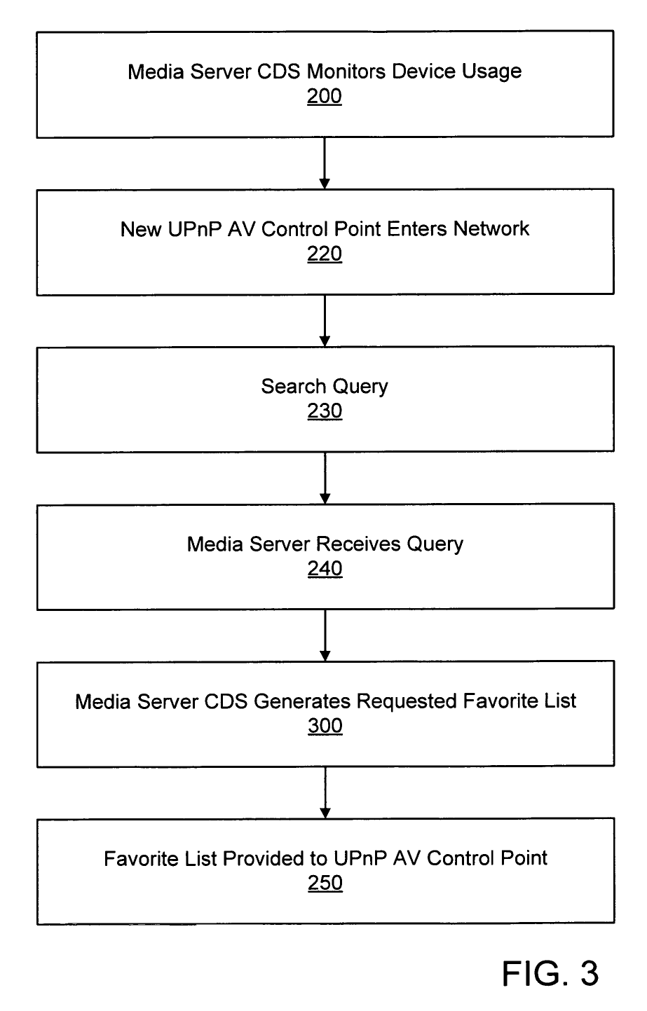

A process showing an alternative embodiment of the invention is depicted in FIG. 3. Like the process of FIG. 2, at 200, the CDS 130 of a media server 120 for a local UPnP network 110 monitors the usage of UPnP devices within the local UPnP network 110, keeping track of the number of times each media item has been requested, accessed, and/or played by devices. Unlike the process of FIG. 2, however, no favorite lists are generated at this time. At 220, a new UPnP AV control point 100 enters the local UPnP network 110, which is serviced by a media server. At 230, a user enters a search query for the most popular media items of a particular criteria. At 240, this query is received by the media server 120. At 300, the media server 120 creates a favorite list based upon the search request and the monitored information concerning the requested, accessed and/or played media items. At 250, the generated favorite list is transmitted to the UPnP AV control point 100.

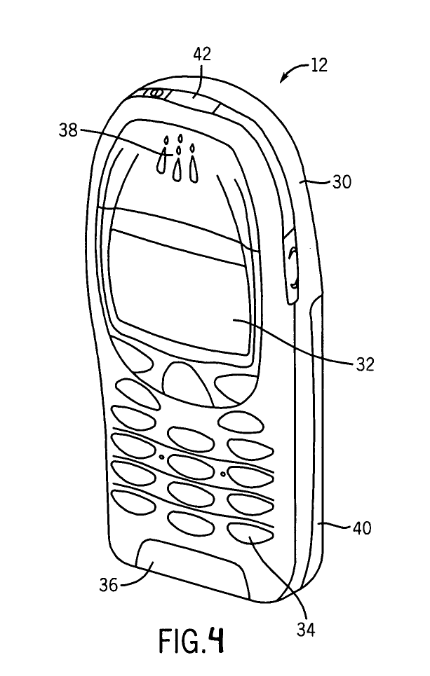

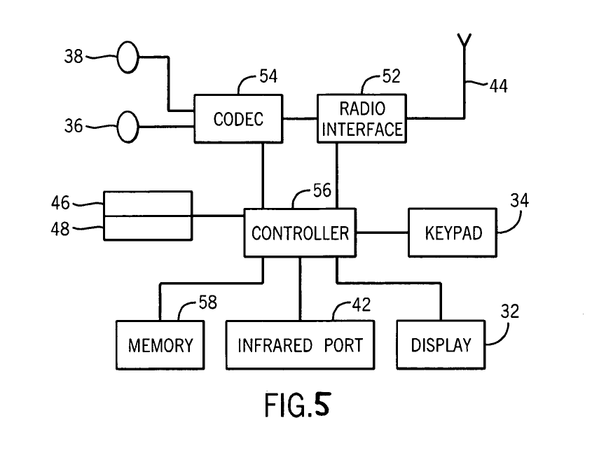

FIGS. 4 and 5 show one representative mobile telephone 12 within which the present invention may be implemented. It should be understood, however, that the present invention is not intended to be limited to one particular type of mobile telephone 12 or other electronic device. Instead, electronic devices such as personal digital assistants, laptop computers, integrated messaging devices, and other devices may be used, both as a requesting device and as a media server. The mobile telephone 12 of FIGS. 4 and 5 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

Communication devices of the present invention may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of providing search result information to a requesting UPnP control point, comprising:
monitoring usage information concerning a plurality of media items on a media server;
receiving a request from the requesting UPnP control point for a favorite list of a particular criterion in relation to the plurality of media items; and
in response to the request, providing to the user the favorite list based upon the monitored usage information.

2. The method of claim 1, wherein each of the plurality of media items comprise content selected from the group consisting of audio content, video content, image content, and combinations thereof.

3. The method of claim 1, wherein the favorite list is generated in response to the request.

4. The method of claim 1, wherein the favorite list is generated before receiving the request.

5. The method of claim 1, wherein the particular criterion comprises the number of times each media item has been accessed.

6. The method of claim 1, wherein the particular criterion comprises the number of times each genre of media items has been accessed.

7. The method of claim 1, wherein the particular criterion comprises the number of times media items by particular artists has been accessed.

8. The method of claim 1, wherein the particular criterion comprises the number of times media items of particular time periods has been accessed.

9. The method of claim 1, wherein the particular criterion comprises the number of times media items including particular individuals has been accessed.

10. The method of claim 1, wherein the particular criterion comprises the number of times media items from particular music albums has been accessed.

11. The method of claim 1, wherein the request is customizable to limit the provided list to a specified number of media items.

12. A computer program product, embodied in a computer-readable medium, for providing search result information to a requesting UPnP control point, comprising:
computer code for monitoring usage information concerning a plurality of media items on a media server;
computer code for receiving a request from the requesting UPnP control point for a favorite list of a particular criterion in relation to the plurality of media items; and
computer code for, in response to the request, providing to the user the favorite list of the particular criterion based upon the monitored usage information.

13. The computer program product of claim 12, wherein each of the plurality of media items comprise content selected from the group consisting of audio content, video content, image content, and combinations thereof.

14. The computer program product of claim 12, wherein the favorite list is generated in response to the request.

15. The computer program product of claim 12, wherein the favorite list is generated before receiving the request.

16. The computer program product of claim 12, wherein the particular criterion comprises the number of times each media item has been accessed.

17. The computer program product of claim 12, wherein the particular criterion comprises the number of times each genre of media items has been accessed.

18. The computer program product of claim 12, wherein the particular criterion comprises the number of times media items by particular artists has been accessed.

19. The computer program product of claim 12, wherein the request is customizable to limit the provided list to a specified number of media items.

20. A UPnP media server in at least selective communication with a UPnP control point, comprising:
a processor; and
a memory unit communicatively connected to the processor and including a content directory service configured to:
monitor usage information concerning a plurality of media items on a media server;
receive a request from the requesting UPnP control point for a favorite list of a particular criterion in relation to the plurality of media items; and
in response to the request, provide to the user the favorite list of the particular criterion based upon the monitored usage information.

21. The UPnP media server of claim 20, wherein each of the plurality of media items comprise content selected from the group consisting of audio content, video content, image content, and combinations thereof.

22. The UPnP media server of claim 20, wherein the favorite list is generated in response to the request.

23. The UPnP media server of claim 20, wherein the favorite list is generated before receiving the request.

24. The UPnP media server of claim 20, wherein the particular criterion comprises the number of times each media item has been accessed.

25. The UPnP media server of claim 20, wherein the request is customizable to limit the provided list to a specified number of media items.

26. A method of obtaining search result information from a UPnP media server, comprising:
requesting from the UPnP media server within a UPnP network a favorite list of a particular criterion in relation to the plurality of media items; and
in response to the request, receiving from the UPnP media server the favorite list of the particular criterion, the favorite list being based upon usage information monitored by the UPnP media server.

27. The method of claim 26, wherein each of the plurality of media items comprise content selected from the group consisting of audio content, video content, image content, and combinations thereof.

28. The method of claim 26, wherein the particular criterion comprises the number of times each media item has been accessed.

29. The method of claim 26, wherein the particular criterion comprises the number of times each genre of media items has been accessed.

30. The method of claim 26, wherein the particular criterion comprises the number of times media items by particular artists has been accessed.

31. The method of claim 26, wherein the particular criterion comprises the number of times media items of particular time periods has been accessed.

32. The method of claim 26, wherein the particular criterion comprises the number of times media items including particular individuals has been accessed.

33. The method of claim 26, wherein the particular criterion comprises the number of times media items from particular music albums has been accessed.

34. The method of claim 26, wherein the request is customizable to limit the provided list to a specified number of media items.

35. A computer program product, embodied in a computer readable medium, for obtaining search result information from a UPnP media server, comprising:
computer code for requesting from the UPnP media server within a UPnP network a favorite list of a particular criterion in relation to the plurality of media items; and
computer code for, in response to the request, receiving from the UPnP media server the favorite list of the particular criterion based upon usage information monitored by the UPnP media server.

36. A UPnP electronic device, comprising:
a processor; and
a memory unit operatively connected to the processor and including:
computer code for requesting from a UPnP media server within a UPnP network a favorite list of a particular criterion in relation to the plurality of media items on the media server; and
computer code for, in response to the request, receiving from the UPnP media server the favorite list of the particular criterion, the favorite list being based upon usage information monitored by the UPnP media server.
